(19) United States
(12) Patent Application Publication
(10) Pub. No.: US 2008/0048143 A1
(43) Pub. Date: Feb. 28, 2008

(54) Plumbing control assembly

(76) Inventors: Jeffery S. Gassman, Mount Horeb, WI (US); Drue J. Schlachter, Fall River, WI (US)

Correspondence Address: QUARLES & BRADY LLP, 33 E. MAIN ST, SUITE 900, P.O BOX 2113, MADISON, WI, 53701-2113, US

(21) Appl. No.: 11/445,418

(22) Filed: Jun. 1, 2006

(51) Int. Cl. F16K 31/02

(52) U.S. Cl. 251/129.04

(57) ABSTRACT

An assembly for controlling the flow, and ultimately the temperature, of water in a water supply line to a plumbing fixture that includes at least one valve capable of external activation in fluid connection with the at least one water supply line, the valve being capable of transitioning between a closed position and an open position to regulate flow through the at least one water supply line and at least two electrically operated controls in connection with a valve capable of external activation, wherein one of the controls is remote from the plumbing fixture.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

A user seeking to issue water from a plumbing fixture, such as a bathtub faucet or shower head, typically manipulates manual valves connected to separate hot and cold water intake supply lines, thereby controlling not only water flow rate, but also water temperature. The separate lines eventually merge into a single line. Alternatively, the hot water supply line and the cold water supply line are connected to a mixing valve that can be manipulated so that the temperature of water issuing from the plumbing fixture is that of the cold water, that of the hot water or that an intermediate temperature. A drawback to both control systems is that a user must adjust the valve(s) to a desired temperature each time that the plumbing fixture is operated.

Newer water temperature and flow systems include electronics. See U.S. Pat. Nos. 4,420,811; 4,700,884; and 4,923,116 (now Re. 35,018). U.S. Published Patent Application No. 2001/0044954 by DiCarlo provides an electronic control pad to independently vary the flow of hot and cold water via electronically operated valves. DiCarlo, however, is impractical in that it requires four reversible, electric, motor-operated valves for operation, as well as controls to operate the four valves—that is, a separate valve for controlling the flow of water through a hot water supply line and through a cold water supply line, as well as a separate valve for controlling the flow of water through a bathtub faucet or through a shower head. In addition, each valve has variable positions, thereby requiring that the valves continuously re-adjust to maintain a constant water temperature. As such, the system disclosed in DiCarlo is complex, is expensive and is incompatible with existing plumbing.

For the foregoing reasons, there is a need for a simple electrical control that can supplement existing manual valves that deliver water to a plumbing fixture.

### BRIEF SUMMARY

The present invention relates to the observation that it is inconvenient, if not impossible, to establish an exact temperature of water issuing from a plumbing fixture by readjusting manual valves upon each use. In addition, the present invention relates to the observation that electronic systems designed to establish constant water temperature are complex, expensive and not easily adapted to existing plumbing. These observations suggest that placement of a valve capable of activation by an external signal on water supply lines allows for an initial adjustment of water flow and water temperature with existing manual valves that is thereafter simply turned on or turned off by the valve.

In one aspect, the present invention is summarized in that an assembly for controlling water flow in at least one water supply line includes at least one valve that is capable of activation by an external signal and that is capable of switching between a normally closed position (whereby water does not flow to a plumbing fixture) and an open position (whereby water flows to the plumbing fixture) connected to the at least one water supply line. The assembly also includes at least two electrically operated controls connected to the at least one valve. The controls urge the valve between the positions, thereby controlling water flow. At least one of the controls is located at a location remote from the plumbing fixture.

In some embodiments, the valve is a solenoid valve. In preferred embodiments, the valve is a slow-closing solenoid valve.

In some embodiments, a valve is provided on each of a hot water supply line and a cold water supply line.

In some embodiments, the plumbing fixture is a combination bathtub faucet and shower head.

In some embodiments, more than one control is provided for controlling water flow, with a proximal control located in or near the plumbing fixture and at least one additional distal control located at a location remote from the plumbing fixture. In preferred embodiments, the proximal control is used to stop flow, while the distal control is used to start flow.

In some embodiments, the assembly further includes a hammer arrester provided on the at least one supply line.

In still further embodiments, custom settings for individual users can be invoked when distinct controls are provided and labeled for distinct individuals.

The previously described embodiments of the present invention have many advantages, including a first advantage that existing plumbing, including manual valves, are adapted into the system.

A second advantage of the present invention is that the assembly described herein is more economical and simpler than existing electrical control assemblies.

These and other features, aspects and advantages of the present invention will become better understood from the description that follows. In the description, reference is made to the accompanying drawings, which form a part hereof and in which there is shown by way of illustration, not limitation, embodiments of the invention. The description of preferred embodiments is not intended to limit the invention to cover all modifications, equivalents and alternatives. Reference should therefore be made to the claims recited herein for interpreting the scope of the invention.

### BRIEF DESCRIPTION OF THE DRAWINGS

The invention will be better understood and features, aspects and advantages other than those set forth above will become apparent when consideration is given to the following detailed description thereof. Such detailed description makes reference to the following drawings, wherein:

FIG. 1 shows a view of a combination bathtub faucet and shower head that has been fitted with an electrically operated proximal switch for controlling the flow of water through manual valves; and

FIG. 2 shows a diagram of a combination bathtub faucet and shower head having a electrically operated distal switch.

### DESCRIPTION OF PREFERRED EMBODIMENTS

Unless defined otherwise, all technical and scientific terms used herein have the same meaning as commonly understood by one of ordinary skill in the art to which the invention belongs. Although any methods and materials similar to or equivalent to those described herein can be used in the practice or testing of the present invention, the preferred methods and materials are now described.

Although the embodiments described below describe a combination bathtub faucet and shower head, it is contemplated that one could use the above-described system to control any plumbing fixture, including but not limited to, a kitchen faucet or a water spigot.

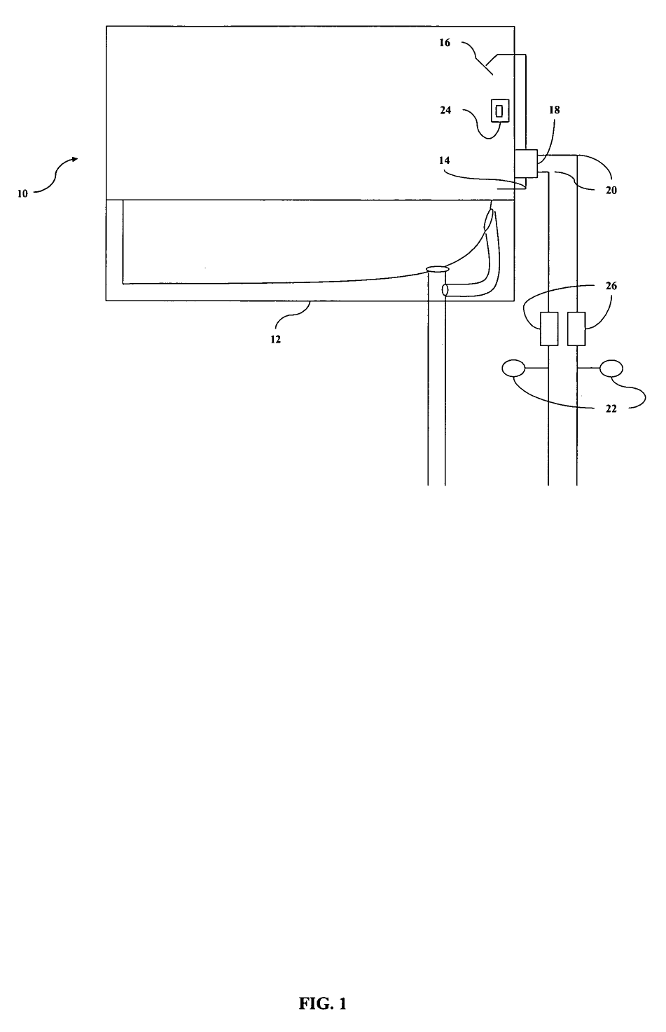

As shown in FIG. 1, a typical bathtub faucet with a shower head combination is indicated generally as 10. The combination 10 includes a bathtub 12 having a faucet 14 and a shower head 16. Typically, manual valves 18 are provided for controlling flow of hot water and of cold water, as well as for directing the flow of water to either the faucet 14 or the shower head 16 from water supply lines 20. The water supply lines 20 can include hammer arresters 22 (commercially available, e.g., from Precision Plumbing Products, Inc.; Portland, Oreg.).

Continuing to refer to FIG. 1, a first embodiment includes an electrically operated control 24, such as a two-way electrical switch. The control 24 can be located either inside the bathtub 10, in which case the control is desirably a low voltage switch to prevent shock, or outside the bathtub 10. The control 24 is in electrical connection with a valve capable of external activation 26, such as slow-closing, and normally closed, solenoid valve, such as a 12 volt GP400 (Parker Hannifin Corp., Fluidex Division; Madison, Mass.). The valve 26 is in fluid connection with a water supply line 20. When the valve 26 is a slow-closing solenoid valve, an occurrence of sudden pressure build-up is attenuated and therefore makes the use of hammer arresters 22 optional. If a separate hot water supply line and cold water supply line are present, then each water supply line 20 is in fluid connection with its own valve 26.

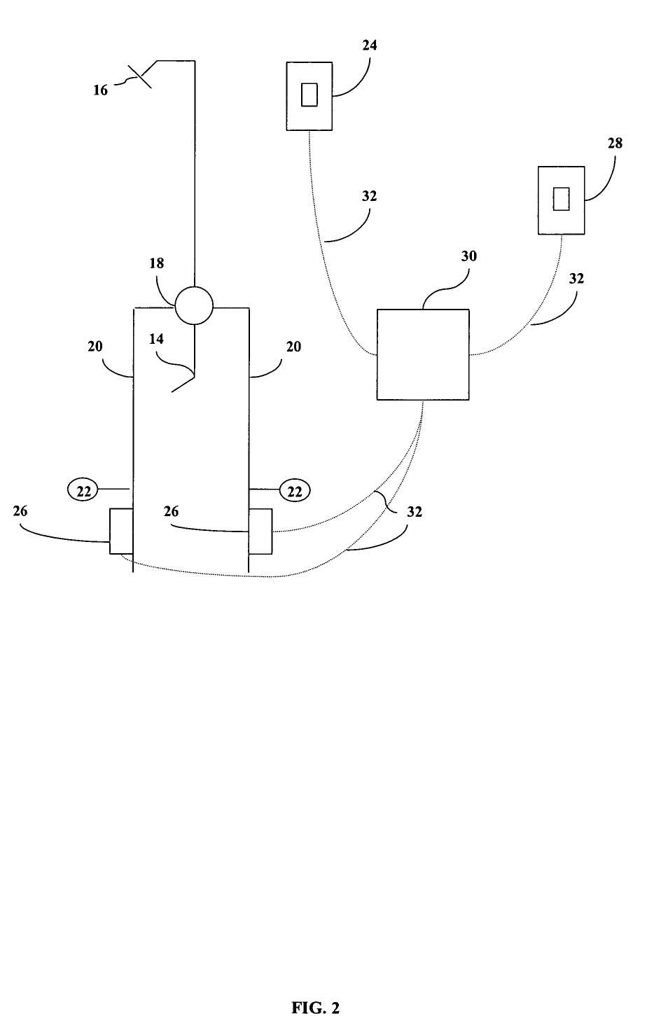

As shown in FIG. 2, which depicts the operable portions of FIG. 1, an alternate embodiment includes a second control 28 placed at a remote location, such as a bedroom. The first control 24 and the second control 28 are in electrically connected to a control box 30 via electrical connections 32, which is thereafter electrically connected to the valves 26 via additional electrical connections 32.

In operation, a user initially adjusts the flow of water with manual valves 18 to establish a desired temperature. However, after the initial setting, the user controls the flow of water, and ultimately the temperature of the water, with control 24 or control 28. For example, after the initial setting, the user would operate control 24 to send an electrical signal to the valve 26, thereby causing the valve 26 to transition to its closed position.

When the user next desires to use the bathtub 10, the user would operate control 24 to send an electrical signal to the valve 26, thereby causing the valve 26 to transition to its open position.

If the control assembly includes the optional second control 28, the user may turn the water on or off from a remote location. A preferred remote location is a bedroom, so that a use may turn the water on upon waking or before entering the room containing the tub or shower.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements within the spirit and the scope of the invention as set forth in the appended claims.

1. An assembly for controlling flow in at least one water supply line to a plumbing fixture, the assembly comprising:
at least one valve capable of external activation in fluid connection with the at least one water supply line, the valve being capable of transitioning between a closed position and an open position to regulate flow through the at least one water supply line; and
at least two electrically operated controls in electrical connection with the valve for urging the valve to transition between the positions, the plumbing fixture and at least one of the controls being in separate rooms.

2. An assembly for controlling water flow as recited in claim 1, wherein the valve capable of external activation is a solenoid valve.

3. An assembly for controlling water flow as recited in claim 2, wherein the solenoid valve is slow-closing.

4. An assembly for controlling water flow as recited in claim 1, wherein the at least one water supply line comprises a hot water supply line and a cold water supply line.

5. An assembly for controlling water flow as recited in claim 1 having two electrically operated controls, wherein a first control is located in or near the plumbing fixture and a second distal control is located at a location remote from the plumbing fixture.

6. An assembly for controlling water flow as recited in claim 1, further comprising at least one water hammer arrester in fluid connection with the at least one water supply line.

7. An assembly for controlling water flow as recited in claim 1, wherein the electrically operated controls are two-way switches.
